(19) United States
(12) Patent Application Publication
(10) Pub. No.: US 2018/0229466 A1
(43) Pub. Date: Aug. 16, 2018

(54) INTERIOR/EXTERIOR COVERING MEMBER FOR AUTOMOBILE, AND MANUFACTURING METHOD THEREOF

(71) Applicant: SUMINOE TEXTILE CO., LTD., Osaka-shi, Osaka (JP)

(72) Inventors: Yoshihiko HATA, Kouka-shi, Shiga (JP); Taro HATTORI, Osaka-shi, Osaka (JP); Osamu TOMITA, Nara (JP)

(73) Assignee: Suminoe Textile Co., Ltd., Osaka-shi, Osaka (JP)

(21) Appl. No.: 15/751,531

(22) PCT Filed: Aug. 10, 2015
(86) PCT No.: PCT/JP2015/072642

§ 371 Date: Feb. 9, 2018

(51) Int. Cl. B32B 3/26; B60N 3/04; B60R 13/08; B32B 5/02; B32B 27/12; B32B 5/32; B32B 27/32; B29C 47/00; B29C 47/02; B29C 65/02; B29C 65/78; B29C 65/00; B29C 51/14

(52) U.S. Cl. CPC B32B 3/266; B29K 2101/12; B60R 13/08; B32B 5/022; B32B 27/12; B32B 5/32; B32B 27/32; B29C 47/0066; B29C 47/025; B29C 65/028; B29C 65/7894; B29C 66/45; B29C 66/71; B29C 66/7294; B29C 66/73182; B29C 66/7392; B29C 66/73753; B29C 51/145; B32B 2323/04; B32B 2605/003; B32B 2605/08; B32B 2307/718; B60N 3/048

(57) ABSTRACT

An interior/exterior covering member for an automobile having excellent sound-absorbing performance is provided. The interior/exterior covering member includes an air-permeable fiber layer 2 and a thermoplastic resin layer 3 laminated on one surface of the fiber layer 2. The melt flow rate of the thermoplastic resin is in a range of 2 g/10 min to 500 g/10 min, and a plurality of through-holes 11 penetrating the resin layer in the thickness direction is formed in the thermoplastic resin layer 3.

### FIELD OF THE INVENTION

The present invention relates to an interior/exterior covering member for an automobile, which can be used as an interior covering member for an automobile, such as, e.g., an automobile floor mat and also can be used as an exterior covering member for an automobile, such as, e.g., a fender liner.

In the specification and claims, the term “melt flow rate” means a melt flow rate measured at a test temperature of 190° C. and a test load of 21.2 N in accordance with JIS K7210-1999.

### BACKGROUND ART

Conventionally, a floor carpet is laid on a floor in an automobile for the purpose of improving the feeling of stepping and preventing vibrations from the floor side from being transmitted. As sound-absorbing performance against noise entering into a vehicle compartment from its roof, doors, windows, etc., to maintain quietness in the automobile, for example, a floor carpet for an automobile in which a skin material (carpet base) and a felt-like sound absorbing member are adhesively integrated with an air-permeable adhesive layer formed by melting thermoplastic resin powder is known (see Patent Document 1). Noise coming into a vehicle compartment via its roof, doors, windows, etc., passes through the air-permeable adhesive layer and reaches the felt-like sound absorbing member. The noise is absorbed here.

### PRIOR ART

### Patent Document

### Patent Document 1: Japanese Examined Utility Model Application Publication No. 1-7636

### SUMMARY OF THE INVENTION

### Problems to be Solved by the Invention

Incidentally, in recent years, in order to further improve comfort in an automobile, it becomes strongly required to further enhance quietness in a compartment space of an automobile. However, the sound absorbing performance against noise is insufficient in the aforementioned conventional sound absorbing floor carpet, and it has been strongly required to further improve the sound-absorbing performance.

Further, even in an exterior covering member for an automobile, such as, e.g., a fender liner, it was strongly demanded to further improve the sound-absorbing performance.

The present invention was made in view of the aforementioned technical background, and aims to provide an interior/exterior covering member for an automobile having excellent sound-absorbing performance and also to provide its manufacturing method and a method for producing an automobile interior/exterior covering shaped article having excellent sound-absorbing performance.

### Means for Solving the Problems

In order to attain the aforementioned object, the present invention provides the following means.

[1] An interior/exterior covering member for an automobile, comprising:

an air-permeable fiber layer; and

a thermoplastic resin layer laminated on one surface of the fiber layer, wherein

a melt flow rate of a thermoplastic resin of the thermoplastic resin layer is in a range of 2 g/10 min to 500 g/10 min, and

a plurality of through-holes is formed in the thermoplastic resin layer so as to penetrate the thermoplastic resin layer in a thickness direction of the resin layer.

[2] The interior/exterior covering member for an automobile as recited in the aforementioned Item 1, wherein

an inner diameter of the through-hole is 0.1 mm to 5.0 mm, and

an arrangement density of the through-holes is 1,000 pieces/m² to 30,000 pieces/m².

[3] The interior/exterior covering member for an automobile as recited in the aforementioned Item 1 or 2, wherein the fiber layer is made of a nonwoven fabric having a fineness of a constituent fiber of 0.1 decitex to 100 decitex.

[4] The interior/exterior covering member for an automobile as recited in the aforementioned Item 1 or 2, wherein the fiber layer is a carpet original fabric in which piles having a weight per unit area of 250 g/m² to 2,000 g/m² are implanted on one surface of a base fabric having a weight per unit area of 80 g/m² to 150 g/m², and

the thermoplastic resin layer is laminated on the other surface of the base fabric.

[5] The interior/exterior covering member for an automobile as recited in any one of the aforementioned Items 1 to 4, wherein

a formation amount of the thermoplastic resin layer is in a range of 50 g/m² to 5,000 g/m².

[6] The interior/exterior covering member for an automobile as recited in any one of the aforementioned Items 1 to 5, wherein

a plurality of vent holes are formed in the fiber layer in a thickness direction from the one surface thereof to an intermediate position thereof or the other surface thereof, and

the vent hole is communicated with the through-hole of the thermoplastic resin layer.

[7] A method for producing an interior/exterior covering member for an automobile, the method comprising:

pressing a thermoplastic resin film immediately after extrusion obtained by extruding a thermoplastic resin having a melt flow rate of 2 g/10 min to 500 g/10 min from an extruder and an air-permeable fiber layer in a superimposed manner with a pair of rolls,

wherein as a first roll in contact with the thermoplastic resin film among the pair of rolls, a cooling type roll having a plurality of perforating protrusions protruded on an outer peripheral surface thereof is used.

[8] A method for producing an internal/external shaped article for an automobile, comprising:

thermoforming the interior/exterior covering member for an automobile as recited in any one of the aforementioned Items 1 to 6 to thereby obtain a shaped article.

[9] The method for producing an internal/external shaped article for an automobile as recited in the aforementioned Item 8, wherein

the thermoforming is performed so that the thermoplastic resin layer is impregnated into a part of the one surface of the fiber layer so as to cause a partial fracture of the thermoplastic resin layer to form a thermoformed hole penetrating the thermoplastic resin layer of the obtained shaped article in a thickness direction thereof.

[10] The method for producing an internal/external shaped article for an automobile as recited in the aforementioned Item 8 or 9, wherein

an inner diameter of both end openings of the through-hole is reduced by softening or melting of the thermoplastic resin layer during the thermoforming.

### Effects of the Invention

In the invention of the aforementioned Item [1], since it is provided with an air-permeable fiber layer, the sound arrived at the fiber layer side is absorbed in the fiber layer. Further, since a plurality of through-holes penetrating the thermoplastic resin layer in the thickness direction is formed, the sound arrived at the thermoplastic resin layer side passes through the air-permeable fiber layer via the through-hole and is absorbed by the fiber layer. For this reason, good sound-absorbing performance can be obtained. Further, the melt flow rate of the thermoplastic resin is set in the range of 2 g/10 min to 500 g/10 min. Therefore, when the interior/exterior covering member for an automobile is thermoformed, a thermoformed hole penetrating the thermoplastic resin layer of the shaped article in the thickness direction is formed. By the synergistic function of the through-hole and the thermoformed hole in the shaped article, excellent sound-absorbing performance can be obtained. Further, since the fiber layer is provided, excellent cushioning property can also be obtained.

Furthermore, according to the interior/exterior covering member for an automobile according to the present invention, by providing the through-holes, it is possible to secure (design) the basic air-permeability for sound absorption and by using (selecting) a thermoplastic resin of a specific melt flow rate within the limited range of a melt flow rate of a thermoplastic resin (2 g/10 min to 500 g/10 min), the configuration (number and size of the hole) of the thermoformed hole can be obtained. With this, the sound-absorbing performance of the shaped article can be controlled (designed). Therefore, for example, although sound-absorbing performance required for each automobile type is different, a configuration of providing the through-hole to secure basic air-permeability can be shared with respect to the required characteristics of such various sound-absorbing performances. For various required sound-absorbing performance, it becomes possible to adjust by selecting the melt flow rate of the thermoplastic resin to be used. With this, since a through-hole forming facility can be shared, there is also an advantage that the equipment cost can be greatly reduced. It becomes extremely expensive if a large number of through-hole forming facilities is prepared for every required sound-absorbing performance. However, according to the present invention, there is also an advantage that such cost increase can be avoided.

According to the invention as recited in the aforementioned Item [2], it is possible to secure excellent sound-absorbing performance while sufficiently securing strength as an interior/exterior covering member for an automobile.

According to the invention as recited in the aforementioned Item [3], as the fiber layer, a nonwoven fabric in which the fineness of the constituent fiber is 0.1 decitex to 100 decitex is used. Therefore, when the interior/exterior covering member for an automobile is thermoformed, the thermoformed hole can be reliably formed, which in turn can obtain better sound-absorbing performance.

In the invention as recited in the aforementioned Item [4], a thermoplastic resin layer is laminated on a carpet original fabric in which piles having a weight per unit area of 250 g/m² to 2,000 g/m² are implanted on one surface of a base fabric having a weight per unit area of 80 g/m² to 150 g/m². Therefore, when the interior/exterior covering member for an automobile is thermoformed, the thermoformed hole can be assuredly formed, which in turn can obtain better sound-absorbing performance.

In the invention as recited in the aforementioned Item [5], the formation amount of the thermoplastic resin layer is in the range of 50 g/m² to 5,000 g/m². Therefore, when the interior/exterior covering member for an automobile is thermoformed, the thermoformed hole can be more assuredly formed, which in turn can obtain better sound-absorbing performance.

In the invention as recited in the aforementioned Item [6], the sound-absorbing performance of the shaped article can be further improved. Among others, when the vent hole is configured so as to communicate from one surface of the fiber layer to the other surface thereof (opened at both surfaces), air-permeability is stabilized, so that better sound-absorbing performance can be obtained.

In the invention as recited in the aforementioned Item [7], the aforementioned interior/exterior covering member for an automobile can be efficiently produced while securing stable quality. Especially since a cooling type roll is used as a roll provided with piercing protrusions on the outer peripheral surface, the cooled piercing protrusion enters the thermoplastic resin layer. With this, the shape of the through-hole formed in the thermoplastic resin layer can be made more uniform.

In the invention as recited in the aforementioned Items [8] and [9], thermoformed holes penetrating the thermoplastic resin layer in the thickness direction are formed in the obtained shaped article. Therefore, by the synergistic function of the through-hole and the thermoformed hole in the shaped article, excellent sound-absorbing performance can be obtained.

In the invention as recited in the aforementioned Item [10], when the interior/exterior covering member for an automobile is thermoformed, the inner diameter of both opening ends of the through-hole is reduced. Therefore, the excellent sound-absorbing performance will be exerted mainly in the fiber layer.

### BRIEF DESCRIPTION OF THE DRAWINGS

FIG. 1 is a cross-sectional view showing one embodiment of an interior/exterior covering member for an automobile according to the present invention.

FIG. 2 is a bottom view of the interior/exterior covering member for an automobile shown in FIG. 1.

FIG. 3 is a cross-sectional view showing another embodiment of the interior/exterior covering member for an automobile according to the present invention.

FIG. 4 is an explanatory diagram showing an example of a production method of an interior/exterior covering member for an automobile according to the present invention.

FIG. 5 is a schematic cross-sectional view showing an example of an automobile interior/exterior covering shaped article obtained by thermoforming the interior/exterior covering member for an automobile shown in FIG. 1.

FIG. 6 is a schematic cross-sectional view showing another example of an automobile interior/exterior covering shaped article obtained by thermoforming the interior/exterior covering member for an automobile shown in FIG. 1.

### EMBODIMENTS FOR CARRYING OUT THE INVENTION

An interior/exterior covering member 1 for an automobile according to the present invention is equipped with an air-permeable fiber layer 2 and a thermoplastic resin layer 3 laminated on one surface of the fiber layer 2. Further, a plurality of through-holes 11 penetrating the thermoplastic resin layer 3 in the thickness direction of the resin layer is formed. In the present invention, a thermoplastic resin having a melt flow rate of 2 g/10 min to 500 g/10 min is used as a thermoplastic resin constituting the thermoplastic resin layer 3.

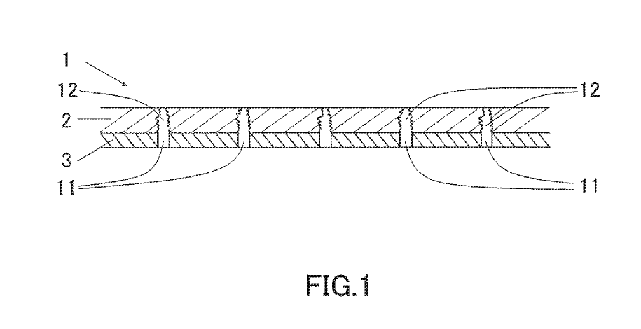

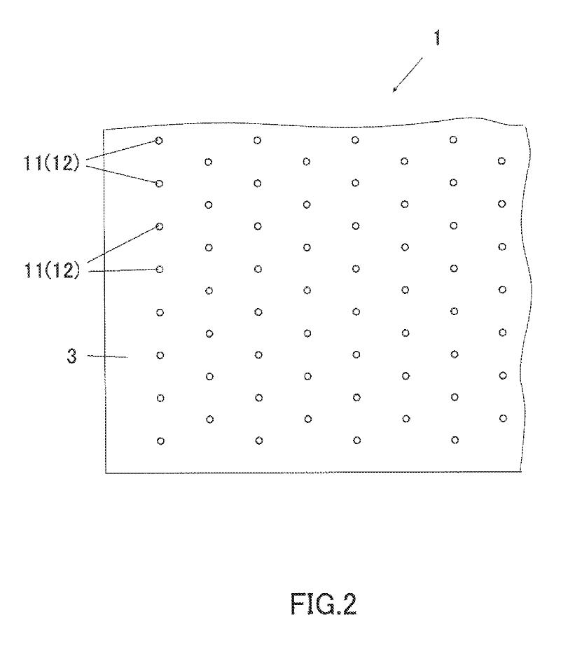

One embodiment of the interior/exterior covering member 1 for an automobile according to the present invention is shown in FIGS. 1 and 2. A plurality of through-holes 11 penetrating the thermoplastic resin layer 3 in the thickness direction of the resin layer 3 is formed, and a plurality of vent holes 12 is formed from the one surface (laminated surface; lower surface) of the fiber layer 2 to the other surface (non-laminated surface: upper surface) of the fiber layer 2. The vent hole 12 is communicated with the through-hole 11 of the thermoplastic resin layer 3 (see FIG. 1). The through-hole 11 and the vent hole 12 communicating with each other constitute a mechanical hole, and in this embodiment, this mechanical hole penetrates in the thickness direction of the interior/exterior covering member 1 for an automobile. That is, in this embodiment, the mechanical hole penetrates the interior/exterior covering member 1 for an automobile in the thickness direction and opens at both faces (see FIG. 1).

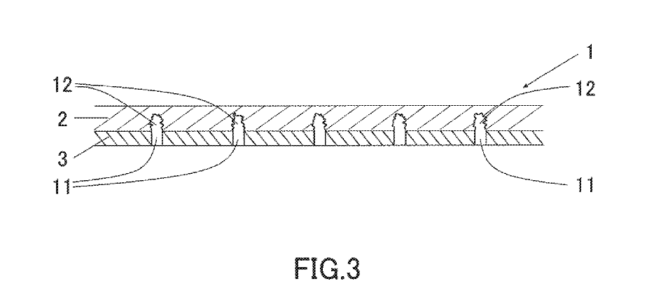

As shown in FIG. 3, it may be configured such that a vent hole 12 communicating with the through-hole 11 is formed from the one surface (laminated surface) of the fiber layer 2 to an intermediate position (intermediate position) in the thickness direction (it may be configured such that the vent hole 12 has not reached the non-laminated surface of the fiber layer 2).

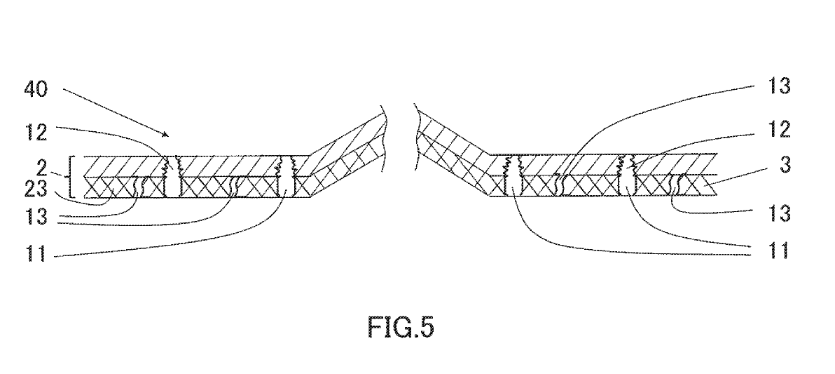

In the interior/exterior covering member 1 for an automobile according to the present invention, since the air-permeable fiber layer 2 is provided, the sound arrived at the fiber layer side is absorbed by the fiber layer 2. Further, since a plurality of through-holes 11 penetrating the thermoplastic resin layer 3 in the thickness direction is formed, the sound arrived at the thermoplastic resin layer side enters the air-permeable fiber layer 2 via the through-hole 11 and is absorbed by the fiber layer 2. Therefore, excellent sound-absorbing performance can be obtained. Further, the melt flow rate of the thermoplastic resin is set in the range of 2 g/10 min to 500 g/10 min. For this reason, when the interior/exterior covering member 1 for an automobile is thermoformed, a thermoformed hole 13 penetrating the thermoplastic resin layer 3 of the shaped article 40 in the thickness direction is formed (see FIG. 5). By the synergistic function of the through-hole 11 and the thermoformed hole 13 in the shaped article 40, excellent sound-absorbing performance can be obtained. Furthermore, when the interior/exterior covering member 1 for an automobile is thermoformed, the thermoplastic resin layer 3 is re-softened or re-melted in the shaped article 40 and the inner diameter of both end openings of the through-hole 11 is reduced, so that even better sound-absorbing performance can be obtained.

In the present invention, the air-permeable fiber layer 2 is not particularly limited, but examples thereof include a nonwoven fabric, a tuft carpet original fabric having piles, and the like. Although the nonwoven fabric is not particularly limited, examples thereof include a needle punch nonwoven fabric, a spunbond nonwoven fabric, and the like.

When a nonwoven fabric is used as the fiber layer 2, the fineness of the constituent fiber is preferably 0.1 decitex to 100 decitex. By setting it to 0.1 decitex or more, it is possible to assuredly form a thermoformed hole penetrating the thermoplastic resin layer in the thickness direction when thermoforming the interior/exterior covering member 1 and by setting it to 100 decitex or less, sufficient sound absorbing performance can be secured. Among other things, the fineness of the fibers constituting the nonwoven fabric is more preferably 2 decitex to 20 decitex.

When a nonwoven fabric is used as the fiber layer 2, the weight per unit area of the nonwoven fabric is preferably set to 200 g/m² to 2,000 g/m². When it is 200 g/m² or more, sufficient sound absorbing property can be secured, and weight reduction can be achieved when it is 2,000 g/m² or less. In particular, the amount of weight per unit area of the nonwoven fabric is more preferably set to 250 g/m² to 500 g/m².

When a tuft carpet original fabric is used as the fiber layer 2, it is preferable to use a nonwoven fabric as abase fabric of the tuft carpet original fabric in that the sound absorption property can be further improved. In addition, the weight per unit area of the base fabric of the tuft carpet original fabric is preferably 80 g/m² to 150 g/m², more preferably 90 g/m² to 120 g/m². Further, the pile weight per unit area of the tuft carpet original fabric is preferably 250 g/m² to 2,000 g/m², more preferably 300 g/m² to 600 g/m².

As the fiber layer 2, for example, a fiber layer having a structure in which two or more layers of nonwoven fabrics composed of fibers mutually different in fineness are laminated may be used, or a fiber layer (e.g., a nonwoven fabric layer) in which a latex layer is provided on the laminated surface of the thermoplastic resin layer 3 may be used.

The thermoplastic resin constituting the thermoplastic resin layer 3 is not particularly limited as long as it is a thermoplastic resin having a melt flow rate (MFR) in the range of 2 g/10 min to 500 g/10 min, and examples thereof include polyolefin, and an olefin based copolymer. When the MFR is less than 2 g/10 min, it becomes difficult to form a thermoformed hole 13 penetrating the thermoplastic resin layer in the thickness direction when thermoforming the interior/exterior covering member 1 and it also becomes difficult to reduce the inner diameter of both end openings of the through-hole 11 when thermoforming the interior/exterior covering member 1. On the other hand, when the MFR exceeds 500 g/10 min, the thermoplastic resin flows excessively when thermoforming the interior/exterior covering member 1, resulting in too small airflow resistance of the obtained shaped article 40, which in turn cannot secure sufficient sound-absorbing performance. In particular, the melt flow rate of the thermoplastic resin is preferably 5 g/10 min to 200 g/10 min.

In cases where the melt flow rate (MFR) of the thermoplastic resin is 5 g/10 min to 50 g/10 min, when thermoforming the interior/exterior covering member 1, the inner diameter of both end openings of the through-hole 11 is reduced so that more excellent sound-absorbing performance can be exerted mainly in the fiber layer 2.

Further, in cases where the melt flow rate (MFR) of the thermoplastic resin is 100 g/10 min to 200 g/10 min, when thermoforming the interior/exterior covering member 1, the thermoplastic resin can be sufficiently impregnated in the fiber layer 2, which can improve the air-permeability of the shaped article to thereby exhibit better sound-absorbing performance.

In cases where the thermoplastic resin contains a filler, an additive, and the like, which will be described later, it is necessary that the melt flow rate in the state containing them is in the range of 2 g/10 min to 500 g/10 min.

In cases where a filler is contained in the thermoplastic resin constituting the thermoplastic resin layer 3, when thermoforming the interior/exterior covering member 1, the filler serves as a starting point (nucleus) for forming the thermoformed hole 13. For this reason, it becomes easier to form the thermoformed hole 13. The filler is not particularly limited, but examples thereof include calcium carbonate, aluminum hydroxide, barium sulfate, talc, mica, and the like.

The formation amount (adhered amount) of the thermoplastic resin layer 3 is preferably set in the range of 50 g/m² to 5,000 g/m². When it is 50 g/m² or more, it is possible to stably form a uniform film layer (thermoplastic resin layer 3) and the thermoformed hole 13 can be more assuredly formed when the thermoforming interior/exterior covering member 1 for an automobile is thermoformed when it is 5,000 g/m² or less, so that better sound-absorbing performance can be obtained. Among them, the formation amount (adhesion amount) of the thermoplastic resin layer 3 is more preferably set within the range of 150 g/m² to 2,500 g/m².

The inner diameter of the mechanical hole (through-hole, vent hole) is preferably set to 0.1 mm to 5.0 mm. When it is 0.1 mm or more, excellent sound-absorbing performance can be secured and when it is 5.0 mm or less, the reduction of the inner diameter of both opening ends of the mechanical hole (through-hole, vent hole) can be attained by heating. In particular, it is particularly preferable that the inner diameter of the mechanical hole (through-hole, vent hole) is set to 0.5 mm to 2.0 mm.

The arrangement density of the mechanical holes (through-holes, vent holes) is preferably set to 1,000 pieces/m² to 30,000 pieces/m², more preferably 3,900 pieces/m² to 8,000 pieces/m².

It should be noted that the arrangement of the mechanical holes (through holes, vent holes) is not limited to the arrangement shown in FIG. 2.

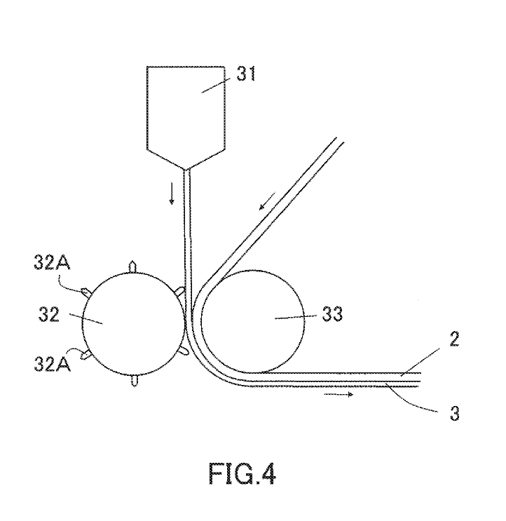

Next, the production method of the interior/exterior covering member 1 for an automobile according to the present invention will be described with reference to FIG. 4. In FIG. 4, the reference numeral 31 denotes an extrusion die connected to an extruder. The reference numeral 32 denotes a first roll. As the first roll, a cooling type roll, such as, e.g., a water-cooled roll, is used. A plurality of piercing protrusions 32A is formed on the outer peripheral surface of the first roll (cooling type roll) 32 in a protruded manner. In this embodiment, the shape of the piercing protrusion 32A is a pointed tip shape having a conical tip at the tip of a columnar base as shown in FIG. 4, but is not particularly limited to such a shape, and, for example, may be a polygonal pyramid shape, such as, e.g., a triangular pyramid shape, a quadrangular pyramid shape, a pentagonal pyramidal shape, a hexagonal pyramidal shape, etc., in addition to a cylindrical shape and a conical shape. Further, the reference numeral 33 denotes a second roll, and its outer peripheral surface is a smooth outer peripheral surface on which no protrusion and the like is formed. In this embodiment, as the second roll 33, a normal temperature roll is used, but the second roll 33 is not particularly limited to a room temperature type roll. As the second roll 33, it is preferable to use a rubber roll. Examples of the rubber roll include a silicone rubber roll and the like.

As shown in FIG. 4, a thermoplastic resin film 3 immediately after extrusion obtained by extruding a thermoplastic resin having a melt flow rate of 2 g/10 min to 500 g/10 min from an extrusion die 31 of an extruder and an air-permeable fiber layer 2 are pressed between a pair of rolls 32 and 33 in a superimposed manner. At this time, they are pressed by the first roll (cooling type roll) 32 and the second roll 33 in a state in which the first roll 32 is in contact with the thermoplastic resin film 3 immediately after extrusion and the second roll 33 is in contact with the fiber layer 2.

With the pressure clamping between the pair of rolls 32 and 33, a piercing protrusion 32A on the outer circumferential surface of the first roll 32 penetrates at least the thermoplastic resin film (thermoplastic resin layer) 3 in the thickness direction. As a result, a thermoplastic resin layer 3 in which a plurality of through-holes 11 are provided is formed. At the same time, the thermoplastic resin layer 3 is integrally laminated on one surface of the fiber layer 2. In this manner, an interior/exterior covering member 1 for an automobile according to the present invention can be obtained.

By configuring so as to design and produce such that at the time of pressure clamping by the pair of rolls 32 and 33, the piercing protrusion 32A of the first roll 32 penetrates the thermoplastic resin film (thermoplastic resin layer) 3 in the thickness direction and further penetrates the fiber layer 2 to the other surface (non-lamination surface: the surface in contact with the second roll 33), an interior/exterior covering member 1 for an automobile shown in FIG. 1 can be produced.

In the aforementioned production method, the through-holes 11 (and vent holes 12 in the fiber layer 2) are formed in the thermoplastic resin layer 3 at the same time when bonding to the fiber layer 2. As described above, it is preferable to form holes at the same time when bonding to the fiber layer 2. However, it is not particularly limited to such a production method. For example, it is possible to form through-holes 11 in the thermoplastic resin layer 3 (and the vent holes 12 in the fiber layer 2) after bonding to the fiber layer 2. Alternatively, it is also possible to form the through-holes 11 in the thermoplastic resin layer 3 (and the vent holes 12 in the fiber layer 2) at the same time of the cutting process as a post-process.

Next, a method for producing an automobile interior/exterior covering shaped article 40 using the interior/exterior covering member 1 for an automobile according to the present invention will be described. The automobile interior/exterior covering shaped article 40 having a predetermined shape is produced by subjecting the interior/exterior covering member 1 for an automobile having the aforementioned configuration to thermoforming. The thermoforming method is not particular limited. However, for example, a hot press method can be exemplified. The interior/exterior covering member 1 for an automobile is thermoformed into a shape corresponding to a shape of a chassis, a fender, etc., of an automobile by hot pressing the interior/exterior covering member 1 for an automobile. The heating temperature for the thermoforming is not particularly limited as long as it is a formable temperature, but generally 160° C. to 240° C.

When the thermoplastic resin layer 3 is impregnated into a part of the one surface (laminated surface) side of the fiber layer 2 by the thermoforming, the resin layer 3 is partially broken, such as, e.g., cracked and bored, due to contact with (resin impregnation) the constituent fiber of the fiber layer 2. As a result, the thermoformed hole 13 penetrating the thermoplastic resin layer 3 (resin impregnated fiber layer 23) in the thickness direction is formed in the obtained shaped article 40 (see FIG. 5). The size, number, etc., of the thermoformed hole 13 can be adjusted by the forming amount of the thermoplastic resin layer 3, the fineness of the constituent fiber of the fiber layer 2, as well as the melt flow rate of the thermoplastic resin. The molding shape of the automobile interior/exterior covering shaped article 40 is not particularly limited to that shown in FIG. 5.

The obtained automobile interior/exterior covering shaped article 40 can exert excellent sound-absorbing performance due to the synergistic action of the through-hole 11 and the thermoformed hole 13. That is, excellent sound-absorbing performance can be obtained by the synergistic effect of the absorbing action of a sound entering the fiber layer 2 through the through-hole 11 and the absorbing action of a sound entering the fiber layer 2 through the thermoformed hole 13.

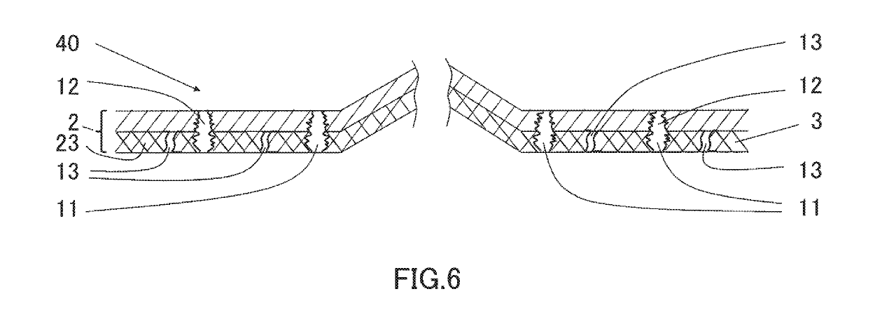

By combining various conditions, such as, e.g., the heating temperature during the thermoforming, a formation amount (g/m²) of the thermoplastic resin layer 3, and the melt flow rate of the thermoplastic resin, an automobile interior/exterior covering shaped article 40 having a cross-sectional shape shown in FIG. 6 is sometimes obtained. That is, in the shaped article 40 shown in FIG. 6, the inner circumferential surface of the through-hole 11 of the thermoplastic resin layer 3 is formed in a fine uneven shape (wavy line shape, etc., in cross-section).

The automobile interior/exterior covering shaped article 40 is suitably used as, for example, a floor mat, a fender liner, an undercover (a cover to be attached to a lower side of an automobile chassis) for an automobile, but the application thereof is not particularly limited to these examples.

### EXAMPLE

Next, specific examples of the present invention will be described, but it should be noted that the present invention is not particularly limited to these examples.

### Example 1

As shown in FIG. 4, a polyethylene resin film 3 immediately after extrusion obtained by extruding a polyethylene resin having a melt flow rate of 100 g/10 min from the extrusion die 31 of an extruder and an air-permeable needle-punched nonwoven fabric 2 having a constituent fiber fineness of 6.6 dtex and a weight per unit area of 250 g/m² were pressed between the first roll (water-cooled type roll) 32 and the second roll 33 described in the preceding paragraph in a state in which the polyethylene resin film 3 and the permeable needle punch nonwoven fabric 2 were superimposed. At this time, as shown in FIG. 4, the first roll (water-cooled type roll) 32 was brought into contact with the polyethylene resin film 3 immediately after extrusion and the second roll 33 was pressed in a manner as to contact with the needle punch nonwoven fabric 2. With this, the piercing protrusion 32A on the outer circumferential surface of the first roll 32 penetrated the thermoplastic resin layer 3 and the needle punch nonwoven fabric 2 in the thickness direction. As a result, a polyethylene resin layer 3 was formed in which a plurality of through-holes 11 was penetrated in the thickness direction, and a needle punch nonwoven fabric layer 2 in which a plurality of vent holes 12 was penetrated in the thickness direction was integrally laminated on one surface of the polyethylene resin layer 3, so that an interior/exterior covering member 1 for an automobile in which the through-hole 11 and the vent hole 12 were communicated was obtained (see FIG. 1).

In the obtained interior/exterior covering member 1 for an automobile, the formation amount of the polyethylene resin layer (thermoplastic resin layer) 3 was 150 g/m², the inner diameter of the through-hole 11 was 1.6 mm, the inner diameter of the vent hole 12 of the laminated surface was 1.6 mm, the inner diameter (opening diameter) of the vent hole 12 of the non-laminated surface was 0.1 mm to 0.2 mm, the arrangement density of the mechanical hole (mechanical hole in which the through-hole 11 and the vent hole 12 are communicated) was 3,900 pieces/m².

An automobile interior/exterior covering shaped article 40 of the aforementioned shape was produced by subjecting the interior/exterior covering member 1 for an automobile to heat pressing at 195° C. Through this thermoforming, a thermoformed hole 13 penetrating the polyethylene resin layer (thermoplastic resin layer) 3 in the thickness direction was newly formed in the obtained shaped article 40 (see FIG. 5).

### Example 2

An interior/exterior covering member 1 for an automobile shown in FIG. 1 was obtained in the same manner as in Example 1 except that a polyethylene resin having a melt flow rate of 150 g/10 min was used instead of a polyethylene resin having a melt flow rate of 100 g/10 min. Furthermore, an automobile interior/exterior covering shaped article 40 was produced by subjecting the interior/exterior covering member 1 for an automobile to hot pressing in the same manner as in Example 1.

### Example 3

An interior/exterior covering member 1 for an automobile shown in FIG. 1 was obtained in the same manner as in Example 1 except that a polyethylene resin having a melt flow rate of 400 g/10 min was used in place of the polyethylene resin having a melt flow rate of 100 g/10 min. Furthermore, an automobile interior/exterior covering shaped article 40 was produced by subjecting the interior/exterior covering member 1 for an automobile to hot pressing in the same manner as in Example 1.

### Example 4

An interior/exterior covering member 1 for an automobile shown in FIG. 1 was obtained in the same manner as in Example 1 except that a polyethylene resin having a melt flow rate of 10 g/10 min was used in place of the polyethylene resin having a melt flow rate of 100 g/10 min. Furthermore, an automobile interior/exterior covering shaped article 40 was produced by subjecting the interior/exterior covering member 1 for an automobile to hot pressing in the same manner as in Example 1.

### Example 5

An interior/exterior covering member 1 for an automobile shown in FIG. 1 was obtained in the same manner as in Example 1 except that a polyethylene resin having a melt flow rate of 50 g/10 min was used instead of the polyethylene resin having a melt flow rate of 100 g/10 min. Furthermore, an automobile interior/exterior covering shaped article 40 was produced by subjecting the interior/exterior covering member 1 for an automobile to hot pressing in the same manner as in Example 1.

### Example 6

The interior/exterior covering member 1 for an automobile shown in FIG. 1 was obtained in the same manner as in Example 1 except that the arrangement density of the mechanical hole (mechanical hole in which the through-hole 11 and the vent hole 12 were communicated) was set to 7,800 pieces/m². Furthermore, an automobile interior/exterior covering shaped article 40 was produced by subjecting the interior/exterior covering member 1 for an automobile to hot pressing in the same manner as in Example 1.

### Example 7

An interior/exterior covering member 1 for an automobile shown in FIG. 1 was prepared in the same manner as in Example 2 except that the arrangement density of the mechanical hole (mechanical hole in which the through-hole 11 and the vent hole 12 were communicated) was set to 7,800 pieces/m². Further, an automobile interior/exterior covering shaped article 40 was produced by subjecting the interior/exterior covering member 1 for an automobile to hot pressing in the same manner as in Example 2.

### Example 8

An interior/exterior covering member 1 for an automobile shown in FIG. 1 was obtained in the same manner as in Example 3 except that the arrangement density of the mechanical hole (mechanical hole in which the through-hole 11 and the vent hole 12 were communicated) was set to 7,800 pieces/m². Furthermore, an automobile interior/exterior covering shaped article 40 was produced by subjecting the interior/exterior covering member 1 for an automobile to hot pressing in the same manner as in Example 3.

### Example 9

The interior/exterior covering member 1 for an automobile shown in FIG. 1 was obtained in the same manner as in Example 4 except that the arrangement density of the mechanical hole (mechanical hole in which the through-hole 11 and the vent hole 12 were communicated) was set to 7,800 pieces/m². Furthermore, an automobile interior/exterior covering shaped article 40 was produced by subjecting the interior/exterior covering member 1 for an automobile to hot pressing in the same manner as in Example 4.

### Example 10

An interior/exterior covering member 1 for an automobile shown in FIG. 1 was obtained in the same manner as in Example 5 except that the arrangement density of the mechanical hole (mechanical hole in which the through-hole 11 and the vent hole 12 were communicated) was set to 7,800 piece/m². Furthermore, an automobile interior/exterior covering shaped article 40 was produced by subjecting the interior/exterior covering member 1 for an automobile to hot pressing in the same manner as in Example 5.

### Example 11

An interior/exterior covering member 1 for an automobile shown in FIG. 1 was prepared in the same manner as in Example 4 except that the arrangement density of the mechanical hole (mechanical hole in which the through-hole 11 and the vent hole 12 were communicated) was set to 11,700 pieces/m². Furthermore, an automobile interior/exterior covering shaped article 40 was produced by subjecting the interior/exterior covering member 1 for an automobile to hot pressing in the same manner as in Example 4.

### Example 12

An interior/exterior covering member 1 for an automobile shown in FIG. 1 was prepared in the same manner as in Example 5 except that the arrangement density of the mechanical hole (mechanical hole in which the through-hole 11 and the vent hole 12 were communicated) was set to 11,700 pieces/m². Furthermore, an automobile interior/exterior covering shaped article 40 was produced by subjecting the interior/exterior covering member 1 for an automobile to hot pressing in the same manner as in Example 5.

In each of the shaped articles 40 obtained in Examples 2 to 12, a thermoformed hole 13 penetrating the polyethylene resin layer (thermoplastic resin layer) 3 in the thickness direction was newly formed through hot pressing (see FIG. 5).

### Comparative Example 1

An interior/exterior covering member 1 for an automobile shown in FIG. 1 was obtained in the same manner as in Example 1 except that a polyethylene resin having a melt flow rate of 0.8 g/10 min was used in place of a polyethylene resin having a melt flow rate of 100 g/10 min. Furthermore, an automobile interior/exterior covering shaped article 40 was produced by subjecting the interior/exterior covering member 1 for an automobile to hot pressing in the same manner as in Example 1. In the obtained shaped article 40, no thermoformed hole 13 penetrating the polyethylene resin layer (thermoplastic resin layer) 3 in the thickness direction was formed.

### Comparative Example 2

An interior/exterior covering member 1 for an automobile shown in FIG. 1 was obtained in the same manner as in Example 1 except that a polyethylene resin having a melt flow rate of 550 g/10 min was used instead of the polyethylene resin having a melt flow rate of 100 g/10 min. Furthermore, an automobile interior/exterior covering shaped article 40 was produced by subjecting the interior/exterior covering member 1 for an automobile to hot pressing in the same manner as in Example 1.

### Comparative Example 3

An interior/exterior covering member 1 for an automobile was obtained in the same manner as in Example 1 except that in place of a water-cooled roll having a piercing protrusion on the outer peripheral surface, as a first roll, a generally cylindrical room temperature roll not having such piercing protrusion was used. In the obtained interior/exterior covering member for an automobile, no mechanical hole was formed. Furthermore, an interior/exterior covering member 1 for an automobile was produced by subjecting the interior/exterior covering member for an automobile to hot pressing in the same manner as in Example 1.

### Comparative Example 4

An interior/exterior covering member for an automobile was obtained in the same manner as in Example 2 except that in place of a water-cooled type roll having a piercing protrusion on the outer peripheral surface, as a first roll, a generally cylindrical room temperature roll not having such piercing protrusion was used. In the obtained interior/exterior covering member for an automobile, no mechanical hole was formed. Furthermore, an automobile interior/exterior covering shaped article was produced by subjecting the interior/exterior covering member for an automobile to hot pressing in the same manner as in Example 2.

In each of the shaped articles obtained in Comparative Examples 2 to 4, a thermoformed hole penetrating the polyethylene resin layer (thermoplastic resin layer) 3 in the thickness direction was formed through hot pressing.

In each of the aforementioned Examples and Comparative Examples, polyethylene resins having a melt flow rate (MFR) of 10 g/10 min, 50 g/10 min, 100 g/10 min, 150 g/10 min, 400 g/10 min, 0.8 g/10 min, 550 g/10 min were used. Such polyethylene resins having different MFRs can be adjusted by selecting polyethylene resins mainly different in molecular weight (number average molecular weight, weight average molecular weight).

TABLE 1

| | | | | | Automobile internal/ | |
|---|---|---|---|---|---|---|
| | Interior/exterior covering material for automobile | | | | external shaped article | |
| | Thermoplastic resin layer | | | | Presence or | |
| | | MFR of | Mechanical hole | | absence of | |
| | Formation | thermoplastic | Inner | Arrangement | formation of | Airflow |
| | amount | resin | diameter | density | thermoformed | resistance |
| | (g/m²) | (g/10 min) | (mm) | (pieces/m²) | hole | (Pa · sec/m) |
| Ex. 1 | 150 | 100 | 1.6 | 3,900 | Presence | 7,300 |
| Ex. 2 | 150 | 150 | 1.6 | 3,900 | Presence | 3,400 |
| Ex. 3 | 150 | 400 | 1.6 | 3,900 | Presence | 2,300 |
| Ex. 4 | 150 | 10 | 1.6 | 3,900 | Presence | 15,000 |
| Ex. 5 | 150 | 50 | 1.6 | 3,900 | Presence | 14,500 |
| Ex. 6 | 150 | 100 | 1.6 | 7,800 | Presence | 4,400 |
| Ex. 7 | 150 | 150 | 1.6 | 7,800 | Presence | 2,500 |
| Ex. 8 | 150 | 400 | 1.6 | 7,800 | Presence | 1,400 |
| Ex. 9 | 150 | 10 | 1.6 | 7,800 | Presence | 7,200 |
| Ex. 10 | 150 | 50 | 1.6 | 7,800 | Presence | 7,100 |
| Ex. 11 | 150 | 10 | 1.6 | 11,700 | Presence | 3,900 |
| Ex. 12 | 150 | 50 | 1.6 | 11,700 | Presence | 3,700 |
| Comp. | 150 | 0.8 | 1.6 | 3,900 | Absence | 22,600 |
| Ex. 1 | | | | | | |
| Comp. | 150 | 550 | 1.6 | 3,900 | Presence | 300 |
| Ex. 2 | | | | | | |

| | | | | | |
|---|---|---|---|---|---|
| Comp. | 150 | 100 | Nil | Presence | ∞ |
| Ex. 3 | | | | | |
| Comp. | 150 | 150 | Nil | Presence | 27,300 |
| Ex. 4 | | | | | |

The sound-absorbing performance of the automobile interior/exterior covering shaped article obtained as described above was evaluated based on the following evaluation method.

### <Sound-Absorbing Performance Evaluation Method>

Airflow resistance of each automobile interior/exterior covering shaped article was measured using a KES air-permeable testing machine (produced by Kato Tech Co., Ltd.). It can be judged that sound-absorbing performance is superior when the air flow resistance (AFR) is in the range of 1,000 Pa·sec/m to 16,000 Pa·sec/m. The KES air-permeable testing machine is configured to measure the pressure loss (the differential pressure from the atmospheric pressure due to the resistance of the test piece at a constant flow rate of 4 cm³/cm²·sec in the standard measurement) using a pressure sensor and directly display the airflow resistance.

As is apparent from Table 1, it was confirmed that the shaped articles obtained by thermoforming the interior/exterior covering members for an automobile of Examples 1 to 12 according to the present invention had airflow resistance of 1,000 Pa·sec/m to 16,000 Pa·sec/m and was excellent in sound-absorbing performance.

On the other hand, it is confirmed when using the interior/exterior covering member for an automobile of Comparative Example 1 in which the melt flow rate of the resin constituting the thermoplastic resin layer was lower than the lower limit of the range defined in the present invention, thermoformed holes were not formed even by thermoforming, the article obtained by thermoforming was deviated in the airflow resistance from the range of 1,000 Pa·sec/m to 16,000 Pa·sec/m, and good sound-absorbing performance could not be obtained.

Further, it was found that the shaped article obtained by thermoforming the interior/exterior covering member for an automobile of Comparative Example 2 in which the melt flow rate of the resin constituting the thermoplastic resin layer was larger than the upper limit of the range defined in the present invention had airflow resistance deviated from the range of 1,000 Pa·sec/m to 16,000 Pa·sec/m, and good sound-absorbing performance could not be obtained.

Further, it also was found that the shaped article obtained by thermoforming the interior/exterior covering member for an automobile of Comparative Examples 3 and 4 in which the through-hole was not formed in the thermoplastic resin layer, had airflow resistance deviated from the range of 1,000 Pa·sec/m to 16,000 Pa·sec/m and good sound-absorbing performance could not be obtained.

### INDUSTRIAL APPLICABILITY

The interior/exterior covering member for an automobile according to the present invention is suitably used as a floor mat, a fender liner, an undercover, etc., for an automobile, but is not particularly limited to these exemplified applications. Normally, in the case of using as a floor mat for an automobile, it is used so that the thermoplastic resin layer 3 side is placed on the floor and in the case of using as a fender liner, the fiber layer 2 is placed on the wheel house side and the thermoplastic resin layer 3 is placed on the tire side, but it is not particularly limited to such a mode of use.

### DESCRIPTION OF REFERENCE SYMBOL

1: interior/exterior covering member for an automobile
2: fiber layer
3: thermoplastic resin layer
11: through-hole
12: vent hole
13: thermoformed hole
32: first roll (cooling type roll)
32A: piercing protrusion
33: second roll
40: automobile interior/exterior covering shaped article

1. An interior/exterior covering member for an automobile, comprising:
an air-permeable fiber layer; and
a thermoplastic resin layer laminated on one surface of the fiber layer, wherein
a melt flow rate of a thermoplastic resin of the thermoplastic resin layer is in a range of 2 g/10 min to 500 g/10 min, and
a plurality of through-holes is formed in the thermoplastic resin layer so as to penetrate the thermoplastic resin layer in a thickness direction of the resin layer.

2. The interior/exterior covering member for an automobile as recited in claim 1, wherein
an inner diameter of the through-hole is 0.1 mm to 5.0 mm, and
an arrangement density of the through-holes is 1,000 pieces/m² to 30,000 pieces/m².

3. The interior/exterior covering member for an automobile as recited in claim 1, wherein
the fiber layer is made of a nonwoven fabric having a fineness of a constituent fiber of 0.1 decitex to 100 decitex.

4. The interior/exterior covering member for an automobile as recited in claim 1, wherein
the fiber layer is a carpet original fabric in which piles having a weight per unit area of 250 g/m² to 2,000 g/m² are implanted on one surface of a base fabric having a weight per unit area of 80 g/m² to 150 g/m², and
the thermoplastic resin layer is laminated on the other surface of the base fabric.

5. The interior/exterior covering member for an automobile as recited in claim 1, wherein
a formation amount of the thermoplastic resin layer is in a range of 50 g/m² to 5,000 g/m².

6. The interior/exterior covering member for an automobile as recited in claim 1, wherein
a plurality of vent holes are formed in the fiber layer in a thickness direction from the one surface thereof to an intermediate position thereof or the other surface thereof, and
the vent hole is communicated with the through-hole of the thermoplastic resin layer.

7. A method for producing an interior/exterior covering member for an automobile, the method comprising:
pressing a thermoplastic resin film immediately after extrusion obtained by extruding a thermoplastic resin having a melt flow rate of 2 g/10 min to 500 g/10 min from an extruder and an air-permeable fiber layer in a superimposed manner with a pair of rolls,
wherein as a first roll in contact with the thermoplastic resin film among the pair of rolls, a cooling type roll having a plurality of perforating protrusions protruded on an outer peripheral surface thereof is used.

8. A method for producing an internal/external shaped article for an automobile, comprising:
thermoforming the interior/exterior covering member for an automobile as recited in claim 1 to thereby obtain a shaped article.

9. The method for producing an internal/external shaped article for an automobile as recited in claim 8, wherein
the thermoforming is performed so that the thermoplastic resin layer is impregnated into a part of the one surface of the fiber layer so as to cause a partial fracture of the thermoplastic resin layer to form a thermoformed hole penetrating the thermoplastic resin layer of the obtained shaped article in a thickness direction thereof.

10. The method for producing an internal/external shaped article for an automobile as recited in claim 8, wherein
an inner diameter of the openings at both ends of the through-hole is reduced by softening or melting of the thermoplastic resin layer during the thermoforming.
